(19) United States
(12) Patent Application Publication
(10) Pub. No.: US 2013/0210601 A1
(43) Pub. Date: Aug. 15, 2013

(54) CENTRIFUGAL SEPARATOR

(71) Applicants: Jie Zheng, Solna (SE); Claes Wase, Tullinge (SE); Rolf Ridderstråle, Stockholm (SE)

(72) Inventors: Jie Zheng, Solna (SE); Claes Wase, Tullinge (SE); Rolf Ridderstråle, Stockholm (SE)

(73) Assignee: ALFA LAVAL CORPORATE AB, Lund (SE)

(21) Appl. No.: 13/819,203

(22) PCT Filed: Aug. 15, 2011
(86) PCT No.: PCT/EP11/64032

§ 371 Date: Apr. 29, 2013

(30) Foreign Application Priority Data
Aug. 27, 2010 (SE) 10174374.8

(51) Int. Cl. B04B 11/02

(52) U.S. Cl. CPC B04B 11/02
USPC 494/53; 248/637; 198/676

(57) ABSTRACT

A centrifugal separator includes a rotor which is rotatable around an axis of rotation. The rotor includes a separation chamber with an inlet for a liquid mixture containing solid particles, at least one liquid outlet for a separated liquid from the liquid mixture, and a solids outlet for the separated solid particles. A screw conveyor is arranged to rotate inside the rotor around the axis of rotation, at a different speed than the rotor. The screw conveyor has at least one conveyor flight for transporting the separated solid particles in the separation chamber towards and out of the solids outlet. The conveyor flight is provided with wear resistant elements arranged along its edge and the wear resistant elements are spaced apart with an interspace between mutually adjacent wear resistant elements.

### FIELD

The present invention relates to a centrifugal separator comprising a rotor which is rotatable around an axis of rotation, the rotor comprising a separation chamber with an inlet for a liquid mixture containing solid particles, at least one liquid outlet for a separated liquid from the liquid mixture, and a solids outlet for the separated solid particles, a screw conveyor being arranged to rotate inside the rotor around the axis of rotation, at a different speed than the rotor, the screw conveyor having at least one conveyor flight for transporting the separated solid particles in the rotor towards and out of the solids outlet, the conveyor flight being provided with wear resistant elements arranged along its edge.

### BACKGROUND

A general problem associated with this kind of centrifugal separator is that the conveyor flight(s) can wear down rapidly in cases where the separated solids are very abrasive. Such separated solids will under certain conditions form a hard and very abrasive solid cake on the inside wall of the rotor, mainly due to the inherent properties of the separated solids in combination with high centrifugal forces resulting from high speed rotation of the rotor. There are many known prior art documents with regard to wear resistant elements attached to the edge of the conveyor flight. Both prior art documents U.S. Pat. No. 4,519,496 A and WO 94/13403 A1 describe a known screw conveyor with wear resistant elements (or so called tiles) attached to the conveyor flight, wherein adjacent tiles are arranged in a side-by-side manner along the edge of the conveyor flight to protect it from wear. Known methods of securing such tiles of ceramic or tungsten carbide plates involve riveting, brazing, or epoxy bonding them to backing plates, which are then welded to the conveyor flight. These tiles are made of a relatively expensive wear resistant material and it can be quite complex and time consuming to attach them all to the edges of the conveyor flight, which in turn will increase the total production cost of the screw conveyor. Furthermore, using a wear resistant material of relatively high density, e.g. tungsten carbide of approx. 13-16 g/cm³, and arranging tiles of this material at the edge of the conveyor flight will increase the total weight and in particular the moment of inertia of the screw conveyor, whereby the energy required to rotating the screw conveyor is increased. It has also been found, that although these known tiles provide good wear protection, it can still be quite difficult to discharge the hard solid cake from the inside wall of the rotor.

### SUMMARY OF THE INVENTION

An object of the present invention is to provide a centrifugal separator and a screw conveyor which reduces the above mentioned problems.

This object is achieved by a centrifugal separator and a screw conveyor. Thus, according to the present invention the initially defined centrifugal separator includes the wear resistant elements spaced apart with an interspace between mutually adjacent wear resistant elements.

Consequently, according to the present invention the wear resistant elements are not arranged in a side-by-side manner (i.e. in abutment with each other) along the edge of the conveyor flight. Instead, they are distributed at a distance from each other, leaving intermediate parts, i.e. the interspaces, of the conveyor flight without any wear resistant elements. Hence, fewer wear resistant elements are arranged along the edge, i.e. at the periphery, of the conveyor flight, reducing both the weight and in particular the moment of inertia as well as the total production time and cost of the screw conveyor. The distance between the wear resistant elements may vary depending on the circumstances. However, spacing the wear resistant elements too far apart may give an inadequate wear protection to the conveyor flight. In this case, the wear protection may be improved by simply reducing the distance between the wear resistant elements. The spacing of the wear resistant elements can be determined with regard to different aspects, such as the operational conditions of the screw conveyor or the cost versus the durability of the screw conveyor.

One skilled in the relevant art would expect a generally poorer wear protection with the conveyor flight having unprotected intermediate parts between the wear resistant elements. However, the inventors have surprisingly found that this arrangement actually has particular advantages. Although, the wear resistant elements are spaced apart, they still provide protection to the intermediate parts, i.e. said interspaces, of the conveyor flight. In spacing the wear resistant elements apart, a cutting effect on the hard solid cake is achieved. Since the screw conveyor rotates at a different speed than the rotor, the wear resistant elements will act as a kind of cutting inserts providing a tangential cutting force on the hard solid cake. This cutting effect will loosen up the hard abrasive cake; making it both easier to discharge and less harmful for the conveyor flight. In general the wear resistant elements could be made of any material which is harder than the conveyor flight. However, in high speed separation of liquid mixtures leaving a hard solid cake on the inside wall of the rotor, the wear resistant elements should be made of a material which is also harder than the hard solid cake. Such wear resistant elements can be made of any suitable wear resistant material, such as oxide or non-oxide ceramics, metals, diamond or any composite material or combination of them.

According to an embodiment of the invention the extension of the interspace along the edge of the conveyor flight is several times greater than the extension of each wear resistant element along the edge of the conveyor flight. Accordingly, the wear resistant elements acting as a kind of cutting inserts can take the form of relatively small reinforced inserts or bits of wear resistant material being attached to the conveyor flight at a relatively long distance from each other. For example, the extension of the interspace may be 2-10 times the extension of each wear resistant element along the edge of the screw. Consequently, this further reduces the production cost of the screw conveyor, since it is not necessary to provide a large number of tiles of considerable size at close proximity to each other. Furthermore, by providing the wear resistant elements in the form of bits or smaller sized pieces, in particular when using a relatively brittle wear resistant material (e.g. ceramics), reduces the risk of them breaking into pieces during operation and thereby damaging the rotor and/or the screw conveyor.

According to a further embodiment of the invention the screw conveyor is made of a polymer. A polymeric material, such as plastic or nylon, is used because of its low density, high chemical stability and low production cost. However, the low wear resistance of this material has greatly limited its application in centrifugal separators. With the present invention, however, the entire screw conveyor with the conveyor flight may be moulded in one integral piece of polymeric material, wherein the wear resistant elements are spaced apart and attached to the conveyor flight for adequate wear protection.

According to yet another embodiment of the invention the surface of the screw conveyor further comprises a wear resistant coating. Hence, the screw conveyor of polymeric material is reinforced with the wear resistant coating, whereby the combination of wear resistant elements and the wear resistant coating provides a cost effective wear protection for the entire screw conveyor. Such a coating may be achieved through several kinds of coating methods. One such method is for example slurry spray coating using organic binders and wear resistant particles. The volume percentage of the wear resistant particles could be varied, but should preferably be greater than 30 percent of the total volume of the slurry, and particles with proper size distribution may be used in order to achieve a high package density. The binders include natural and synthetic resins, such as acrylics, polyesters, melamine resins and epoxies. The wear resistant particles can be of different oxides, carbides, nitrides and diamond, which all have different hardness and provide different wear resistance. The slurry spray coating can easily be performed by any commercial available spray machine. The main advantages of this embodiment are increased wear protection, low production cost and easy thickness variation of the coating.

According to a further embodiment of the invention the wear resistant elements are at least partly embedded in the material of the conveyor flight. The wear resistant elements may for example be moulded into the material of the conveyor flight. The conveyor flight may also be provided with grooves into which the wear resistant elements are fitted and further fastened by any ordinary fastening means, such as screwing, mechanical fitting, gluing or any combination of them. For example, the material of the conveyor flight could be arranged with grooves in the form of cylindrical holes into which wear resistant elements having threaded portions may be screwed. Through this embodiment the wear resistant elements are at least partly integrated into the conveyor flight, whereby it is possible to provide a screw conveyor having a smooth conveyor flight surface with the wear resistant elements being exposed through the non-embedded parts or the openings of the grooves. Hence, each wear resistant element is flush with the surface of the conveyor flight. However, the wear resistant elements could also be arranged to slightly protrude or stick out of the edge or surface of the conveyor flight. In particular they could be arranged to protrude somewhat radially, e.g. 0.1-0.5 mm, to enhance the tangential cutting effect on the hard solid cake in the rotor.

According to another embodiment of the invention the conveyor flight material is configured with undercut grooves for receiving the wear resistant elements of corresponding form, such that the wear resistant elements are retained against the centrifugal forces during rotation of the screw conveyor. The wear resistant elements can be of different shape, e.g. disc, cube, triangular, trapezoid, T-shape, serrated or an irregular shape. Hence, the grooves are of corresponding shape to provide a form fit holding the wear resistant elements against the centrifugal forces resulting from the rotation of the screw conveyor during operation.

According to yet another embodiment of the invention the undercut grooves are provided in a surface of the conveyor flight facing the direction of the solids outlet of the rotor, the undercut grooves extending radially to provide openings at the radially outer edge of the conveyor flight, wherein the wear resistant elements are fitted into the grooves such that they are exposed through both the openings in the radial direction and the openings in the axial direction in the surface of the conveyor flight. Through this embodiment, the wear resistant elements provide the cutting effect on the hard solid cake at parts of the conveyor flight which are more exposed to the abrasive solids. Furthermore, the wear resistant elements are at least partly integrated into the conveyor flight through said undercut grooves, providing a conveyor flight having a relatively smooth surface with integrated wear resistant elements which provide the cutting action in said radial direction and said axial direction (i.e. the surface facing the solids outlet of the rotor).

According to a further embodiment of the invention the rotor and the screw conveyor forms a cylindrical portion and a conical portion along the axis of rotation, the wear resistant elements being arranged along a portion of the conveyor flight which is disposed in a transition zone between the cylindrical portion and the conical portion. Consequently, it is not necessary to arrange the wear resistant elements along the entire length of the conveyor flight. Instead they are arranged only along the portion of the conveyor flight which is affected by the hard abrasive solid cake. It has been found that this place, in many instances, is disposed at the transition zone between the cylindrical portion and the conical portion of the screw conveyor.

According to another embodiment of the invention the rotor is arranged with a support device for the screw conveyor, the support device comprising a holding member disposed at the solids outlet of the rotor, the holding member and the tip of the screw conveyor being configured to cooperate in such a manner that the holding member rotatably receives and supports the tip of the screw conveyor to secure a clearance between the wear resistant elements on the conveyor flight and the inside wall of the rotor. Through this embodiment, the support device will counteract any translational movement of the screw conveyor relative to the rotor during operation. Otherwise, the wear resistant elements could come into contact with the inside wall of the rotor and damage it. In some cases, the screw conveyor could also be mounted to allow a certain translational movement, in a direction along the axis of rotation, relative the rotor. However, if the screw conveyor moves too much towards the solids outlet of the rotor, there is a risk that the conical portion (or said transition zone between the cylindrical portion and the conical portion) of the screw conveyor comes into contact with inside wall of the rotor. This is usually not a problem during operation, since the accumulated separated solids will push the screw conveyor in a direction from the solids outlet and keep the wear the wear resistant elements at a distance from the inside wall of the rotor. However, during a separation start phase when the rotor is empty of accumulated solids, and especially if the centrifugal separator is arranged with a vertical axis of rotation (i.e. as a hanging centrifugal separator), there is a risk that the wear resistant elements will come into contact with the inside wall of the rotor and thereby damage it. Accordingly, this embodiment will secure a clearance between the wear resistant elements on the conveyor flight and the inside wall of the rotor.

According to another embodiment of the invention the holding member has a concave end adapted to receive and support a pointed tip of the screw conveyor. Hereby, the holding member and the tip of the screw conveyor are configured to cooperate in such a manner that the holding member rotatably receives and supports the tip of the screw conveyor.

According to yet another embodiment of the invention the holding member has a pointed end adapted to engage with a recess in the tip of the screw conveyor. Hereby, the holding member and the tip of the screw conveyor are configured to cooperate in such a manner that the holding member rotatably receives and supports the tip of the screw conveyor.

According to a further embodiment of the invention the screw conveyor is mounted to allow a certain translational movement, in a direction along the axis of rotation, relative the rotor, the support device being arranged with an adjustment mechanism for changing the position of the holding member in a direction along the axis of rotation, whereby an adjustment of the position and the clearance of the screw conveyor relative the rotor is achieved. Consequently, this embodiment provides means of adjusting the clearance between the wear resistant elements on the conveyor flight and the inside wall of the rotor.

According to yet another embodiment of the invention the adjustment mechanism of the support device comprises a threaded holding member, which is screwable with a holder body arranged to the rotor, wherein the holding member is arranged to be screwed in the holder body to change the position of the holding member along the axis of rotation.

According to another embodiment of the invention the support device is connected to the rotor through releasable fastening means. The support device may be attached through any fastening means, such as by screwing or clamping it to an open end of the rotor, i.e at the solids outlet end of the rotor. The support device will hereby form an extension of the rotor at the end thereof including apertures forming the solids outlet.

The invention also relates to a screw conveyor as well as a support device for the above defined centrifugal separator.

### BRIEF DESCRIPTION OF THE DRAWINGS

The invention will be further explained by a description of an embodiment in the following with reference to the accompanying drawings.

FIG. 1 is a sectional view of a centrifugal separator according to the invention.

FIG. 2 is a view of the screw conveyor according to the invention.

FIG. 3 is a sectional view of the support device for the screw conveyor according to the invention.

### DETAILED DESCRIPTION

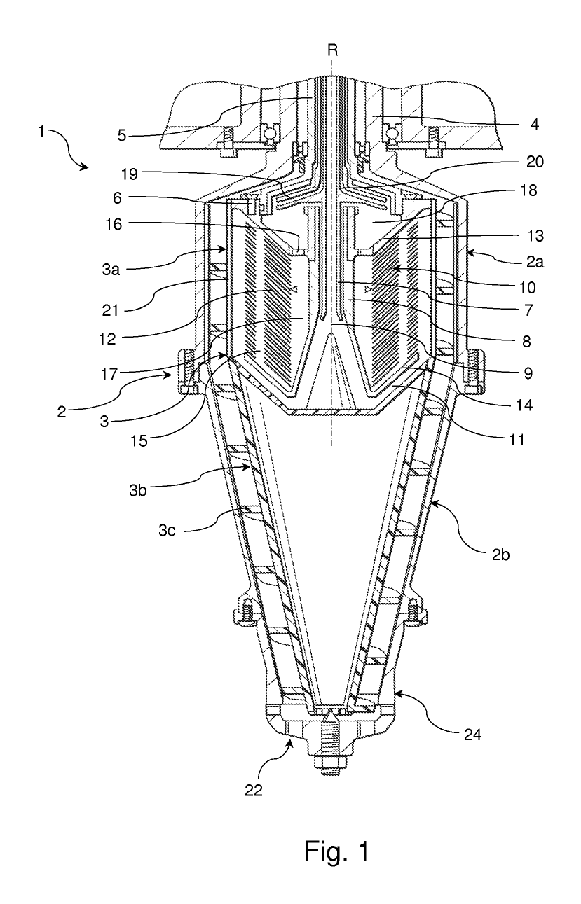

FIG. 1 shows a centrifugal separator 1 according to an embodiment of the invention. The centrifugal separator 1 comprises a rotor 2 which is rotatable at a certain speed around a vertical axis of rotation R, and a screw conveyor 3 which is arranged in the rotor 2 and rotatable around the same axis of rotation R but at a speed which differs from the rotation speed of the rotor 2.

The centrifugal separator 1 is intended to be suspended vertically in a manner indicated by WO 99/65610 A1. The device necessary for suspending and driving the centrifugal separator 1 is therefore not described here.

The rotor 2 has an essentially cylindrical upper rotor portion 2a, and an essentially conical lower rotor portion 2b, the rotor portions 2a and 2b being connected to one another by screws. Alternative connection members can of course be used. The cylindrical rotor portion 2a includes an extension axially upwards in the form of a hollow rotor shaft 4, which is connected to a drive device (not shown) for rotating the rotor 2 around the axis of rotation R.

A further hollow shaft 5 extends into the rotor 2 through the interior of the hollow rotor shaft 4. This hollow shaft 5 supports the screw conveyor 3 by means of screws 6, is drivingly connected to the screw conveyor, and is hereinafter called the conveyor shaft 5. The screw conveyor 3 comprises a cylindrical upper conveyor portion 3a which extends axially inside the cylindrical rotor portion 2a, a conical lower conveyor portion 3b which extends axially inside the conical lower rotor portion 2b, and a conveyor flight 3c which extends in a helical manner along the upper cylindrical portion 3a and the lower conical portion 3b of the screw conveyor 3. The screw conveyor 3 may of course have more than one conveyor flight 3c, e.g. two or three conveyer flights, which all extend in a helical manner along the inside of the rotor 2.

An inlet pipe 7 for a liquid mixture which is to treated in the rotor 2 extends through the conveyor shaft 5 and leads on into a central sleeve 8 in the interior of the screw conveyor 3. The central sleeve 8 delimits an inlet chamber 9 for the liquid mixture, wherein the inlet chamber 9 communicates with a separation chamber 10 via radially extending distribution channels 11.

The separation chamber 10 is an annular space that surrounds the inlet chamber 9 and comprises a stack of truncated conical separation discs 12. The stack is fitted radially inside the cylindrical portion 3a of the screw conveyor 3 and arranged coaxially with the axis of rotation R. The conical separation discs 12 are held together axially between an upper truncated conical support plate 13 and a lower truncated conical support plate 14. As can be seen, the lower support plate 14 is formed in one piece with the central sleeve 8. The separation discs 12 comprise holes which form channels 15 for axial flow and distribution of liquid through the stack of separation discs 12. The lower support plate 14 comprises a corresponding hole (not shown), whereby the distribution channels 11 communicate with the channels 15 for axial flow of liquid in the stack of separation discs 12. The upper support plate 13 comprises a number of holes 16 which connect a radially inner annular space 17, within the stack of separation discs 12, with a liquid outlet chamber 18. Such liquid may for example be oil. A so called paring disc 19 for discharging purified liquid is disposed within the outlet chamber 18. The paring disc 19 is stationary and firmly connected to the inlet pipe 7, wherein the paring disc 19 is communicating with an outlet channel 20 extending in an outlet pipe which surrounds the inlet pipe 7.

The cylindrical portion 3a of the screw conveyor 3 radially surrounds the stack of separation discs 12, wherein the cylindrical portion 3a comprises a number of axially extending apertures 21 which are distributed round the axis of rotation R. The axially extending apertures 21 are provided to allow for the separated particles to pass through and deposit on the inside wall of the cylindrical portion 2a of the rotor 2. Liquid will of course also be able to pass through the apertures 21 in the cylindrical portion 3a of the screw conveyor 3.

The rotor 2 has at its lower end a solids outlet 22 for separated particles (solids). In connection with this solids outlet 22, the rotor could be surrounded by a container (not shown) for intercepting and collecting the solids which leaves the solids outlet 22. The solids are transported by means of the conveyor flight 3c towards and out of the solids outlet 22. Accordingly, during operation, the screw conveyor 3 is arranged to rotate at a different speed than the rotor 2, whereby the solids are discharged by the conveyor flight 3c of the screw conveyor 3. This differential speed between the rotor 2 and the screw conveyor 3 may be constant or varied in a known manner; depending on for instance a desired dryness on the discharged solids and/or the amount of torque needed to drive the screw conveyor 3 for the discharge of the solids. If the solids are very difficult to discharge, the rotor 2 may even be operated in a cycle comprising a solids discharge phase of lower rotational speed than a separation phase. In this way, the solids are discharged more easily as the centrifugal forces inside the rotor 2 are reduced at the lower speed. A known way of operating the centrifugal separator in such a cycle is further described in WO 2011/053224 A1. Furthermore, after an interrupted (or paused) operation, the centrifugal separator may need to be cleared before a restart. Hence, there could be some remaining mixture of solids and liquid inside the stack of separation discs 12, which need to be cleared prior to resuming a separating operation. This may be achieved by bringing the screw conveyor 3 with the stack of separation discs 12 into rotation within a stationary (and empty) rotor 2. In this way, the remaining mixture will be thrown out of the stack and into the inside wall of the stationary rotor, whereon it's easily discharged out of the solids outlet 22 by means of gravity and the rotating screw conveyor 3.

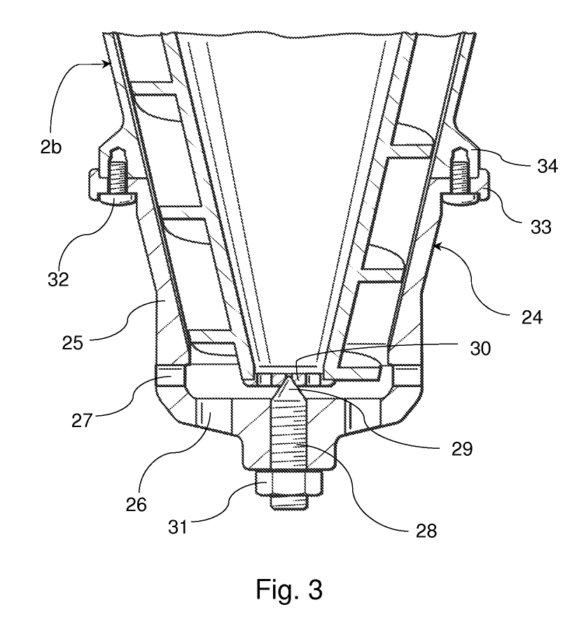

The screw conveyor 3 is made in one piece of a polymer material, such as plastic or nylon, which could be fibre-reinforced. The conical portion 3b has a hollow interior or cavity, which is either sealed or open to the surrounding. If desired, the cavity could be filled with some material having a relatively low density, such as cellular plastic or the like. Furthermore, the lower conical portion 2b of the rotor 2 is arranged with a support device 24 for the screw conveyor which is further described in connection with FIG. 3.

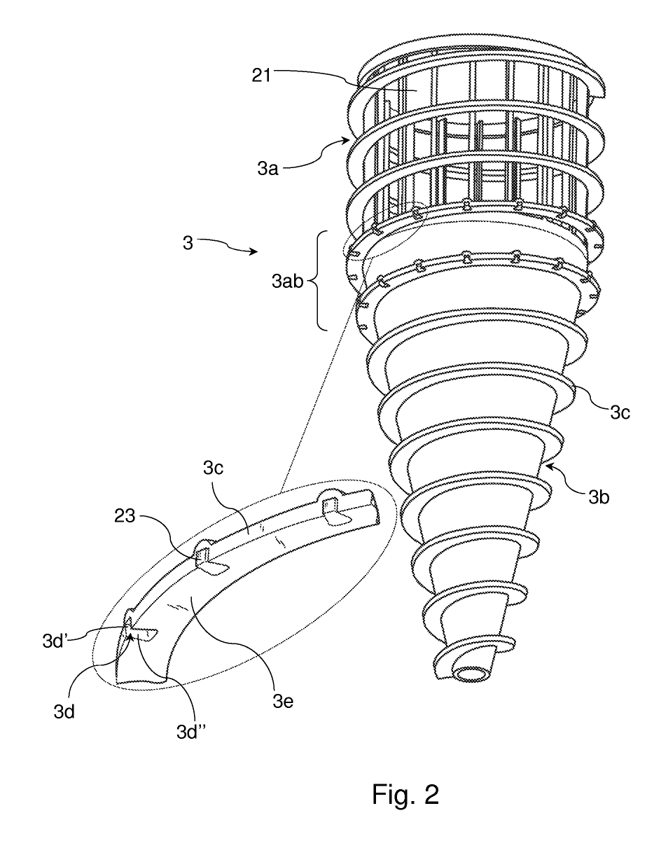

FIG. 2 shows the screw conveyor 3 in isolation and showing an enlarged portion of the conveyor flight 3c provided with wear resistant elements 23 arranged along the conveyor flight edge. The wear resistant elements 23 are spaced apart with an interspace between mutually adjacent wear resistant elements 23, i.e. leaving intermediate parts of the conveyor flight free of wear resistant elements. The extension of the intermediate part of the conveyor flight 3c is at least five times greater than the extension of each wear resistant element 23 along the edge of the flight 3c. As can be seen, the wear resistant elements 23 are in the form of relatively small cutting inserts or bits of wear resistant material, which are attached to the conveyor flight 3c at a relatively long distance from each other. The wear resistant elements 23 are made of a metal and diamond composite with relatively sharp edges arranged for cutting the hard abrasive cake.

The wear resistant elements 23 are arranged only along a portion of the conveyor flight 3c. Accordingly, the wear resistant elements 23 are arranged along a portion of the conveyor flight 3c which is disposed in a transition zone 3ab between the cylindrical portion 3a and the conical portion 3b of the screw conveyor 3. This portion of the conveyor flight 3c is, in this particular embodiment, exposed the most to abrasion by the hard solid cake. Thus, in this embodiment, it has been found that the solids will tend to accumulate and build-up a hard abrasive cake at this transition zone between the cylindrical portion 2a and the conical portion 2b on the inside wall of the rotor 2.

As can be seen, the wear resistant elements 23 are partly embedded in the material of the conveyor flight, wherein the material is configured with undercut grooves 3d for receiving the wear resistant elements 23 of corresponding form. These undercut grooves 3d are provided in the surface of the conveyor flight facing the direction of the solids outlet 22 of the rotor 2, the undercut grooves 23 extending radially to provide openings at the radially outer edge of the conveyor flight 3c, wherein the wear resistant elements 23 are fitted into the grooves 3d such that they are exposed through both the openings in the radial direction and the openings in the axial direction in said surface of the conveyor flight. In this case, each undercut groove 3d has a trapezoid shape to provide a form fit for holding a trapezoid shaped wear resistant element 23 against the centrifugal force resulting from the rotation of the screw conveyor 3 during operation. Furthermore, these wear resistant elements 23 are firmly attached to the grooves 3d using epoxy resin glue.

FIG. 3 shows the lower conical portion 2b of the rotor 2 is arranged with the support device 24 for the screw conveyor 3. The support device 24 comprises a cup-shaped holder body 25 forming an extension of the lower conical rotor portion 2b. A bottom part of the cup-shaped body is provided with axial and radial outlet holes 26 and 27 for discharging the solids from the rotor 2. The cup-shaped body 25 is furthermore provided with a holding member 28 which is screwable with the bottom central part of the holder body 25. As can be seen, the holding member 28 has the form of a threaded bolt with a pointed end 29 adapted to engage with a recess 30 in a disc 31 arranged to the tip of the screw conveyor 3. Hereby, the holding member 28 and the tip of the screw conveyor 3 are configured to cooperate in such a manner that the holding member 28 rotatably receives and supports the tip of the screw conveyor 3 to secure a clearance between the wear resistant elements on the conveyor flight and the inside wall of the rotor. Accordingly, the support device 24 will counteract any translational movement of the screw conveyor 3 relative to the rotor 2 during operation.

In this embodiment, the screw conveyor 3 is mounted to allow a certain translational movement, in a direction along the axis of rotation R, relative the rotor 2. An adjustment mechanism for changing the position of the holding member 28 and thereby the screw conveyor in a direction along the axis of rotation R is provided in this embodiment. This is achieved by screwing the holding member 28 in the cup-shaped holder body 25, whereby the adjustment of the position and the clearance between the wear resistant elements 23 on the conveyor flight 3c and the inside wall of the rotor 2 is achieved. The holding member 28 is locked in a desired position by means of a nut 31 which is threaded on a part of the holding member 28 disposed on the outside of the holder body 25.

The entire support device 24 is detachably connected to the lower conical portion 2b of the rotor 2 by means of screws or bolts 32 which are screwed into mounting flanges 33 and 34 arranged at an upper rim part of the cup-shaped holder body 25 and a corresponding lower rim part of the conical rotor portion 2b respectively.

The invention is not limited to the embodiment disclosed but may be varied and modified within the scope of the claims set out below.

What is claimed is:

1-17. (canceled)

18. A centrifugal separator comprising a rotor which is rotatable around an axis of rotation, the rotor comprising a separation chamber with an inlet for a liquid mixture containing solid particles, at least one liquid outlet for a separated liquid from the liquid mixture, and a solids outlet for the separated solid particles, a screw conveyor being arranged to rotate inside the rotor around the axis of rotation, at a different speed than the rotor, the screw conveyor having at least one conveyor flight for transporting the separated solid particles in the rotor towards and out of the solids outlet, the conveyor flight being provided with wear resistant elements arranged along its edge, characterized in that the wear resistant elements are spaced apart with an interspace between mutually adjacent wear resistant elements.

19. The centrifugal separator according to claim 18, wherein the extension of the interspace along the edge of the conveyor flight is several times greater than the extension of each wear resistant element along the edge of the conveyor flight.

20. The centrifugal separator according to claim 18, wherein the screw conveyor is made of polymer.

21. The centrifugal separator according to claim 20, wherein the surface of the screw conveyor further comprises a wear resistant coating.

22. The centrifugal separator according to claim 20, wherein the wear resistant elements are at least partly embedded in the material of the conveyor flight.

23. The centrifugal separator according to claim 22, wherein the wear resistant elements are attached to the conveyor flight by moulding, screwing, mechanical fitting, gluing or any combination of thereof.

24. The centrifugal separator according to claim 22, wherein the material of the conveyor flight (3c) is configured with undercut grooves (3d) for receiving the wear resistant elements (23) of corresponding form, such that the wear resistant elements (23) are retained against the centrifugal forces during rotation of the screw conveyor.

25. The centrifugal separator according to claim 24, wherein the undercut grooves are provided in a surface of the conveyor flight facing the direction of the solids outlet of the rotor, the undercut grooves extending radially to provide openings at the radially outer edge of the conveyor flight, wherein the wear resistant elements are fitted into the grooves such that they are exposed through both the openings in the radial direction and the openings in the axial direction in the surface of the conveyor flight.

26. The centrifugal separator according claim 18, wherein the rotor and the screw conveyor forms a cylindrical portion and a conical portion along the axis of rotation, the wear resistant elements being arranged along a portion of the conveyor flight which is disposed in a transition zone between the cylindrical portion and the conical portion.

27. The centrifugal separator according to claim 18, wherein the rotor is arranged with a support device for the screw conveyor, the support device comprising a holding member attached to the rotor and disposed at a central part of the solids outlet, the holding member and a tip of the screw conveyor being configured to cooperate in such a manner that the holding member rotatably receives and supports the tip of the screw conveyor to secure a clearance between the wear resistant elements on the conveyor flight and an inside wall of the rotor.

28. The centrifugal separator according to claim 27, wherein the holding member has a concave end adapted to receive and support a pointed tip of the screw conveyor.

29. The centrifugal separator according to claim 27, wherein the holding member has a pointed end adapted to engage with a recess in the tip of the screw conveyor.

30. The centrifugal separator according to claim 27, wherein the screw conveyor is mounted to allow a certain translational movement, in a direction along the axis of rotation, relative the rotor, the support device being arranged with an adjustment mechanism for changing the position of the holding member in a direction along the axis of rotation, whereby an adjustment of the position and the clearance of the screw conveyor relative the rotor is achieved.

31. The centrifugal separator according to claim 30, wherein the adjustment mechanism of the support device comprises a threaded holding member, which is screwable with a holder body arranged to the rotor, wherein the holding member is arranged to be screwed in the holder body to change the position of the holding member along the axis of rotation.

32. The centrifugal separator according to claim 26, wherein the support device is connected to the rotor through releasable fastening means.

33. A screw conveyor for a centrifugal separator, the screw conveyor being arranged to rotate inside a rotor around an axis of rotation at a different speed than the rotor, the screw conveyor having at least one conveyor flight for transporting separated solid particles in the rotor towards and out of a solids outlet, the conveyor flight being provided with wear resistant elements arranged along an edge thereof, the wear resistant elements being spaced apart with an interspace between mutually adjacent wear resistant elements.

34. A support device for a centrifugal separator, the support device comprising a holding member attached to a rotor and disposed at a central part of a solids outlet, the holding member and a tip of a screw conveyor being configured to cooperate in such a manner that the holding member rotatably receives and supports the tip of the screw conveyor to secure a clearance between the wear resistant elements on a conveyor flight and an inside wall of the rotor.
